(19) United States
(12) Patent Application Publication
(10) Pub. No.: US 2022/0394966 A1
(43) Pub. Date: Dec. 15, 2022

(54) Casting Rod Handle

(71) Applicant: Samuel Climer, Flower Mound, TX (US)

(72) Inventor: Samuel Climer, Flower Mound, TX (US)

(21) Appl. No.: 17/335,486

(22) Filed: Jun. 14, 2021

(51) Int. Cl. A01K 87/08; A01K 89/015

(52) U.S. Cl. CPC A01K 87/08; A01K 89/01925

(57) ABSTRACT

An improved casting rod handle utilizing a forward finger trigger hold in relation to the reel and reel seat providing a more comfortable and less injury prone handle and grip position for the user.

### STATEMENT REGARDING FEDERALLY SPONSORED RESEARCH

Not applicable.

### BACKGROUND

The present invention relates to fishing rods and particular an improved handle for a casting rod. Relevant background information is discussed below.

Anglers have practiced and enjoyed fishing for thousands of years whether for food or for sport. The individual anglers seeking to catch a single fish at one time will typically use a rod and reel setup. The rod is typically a long flexible shaft that includes eyelets to thread a length of line through to secure a hook to the casting end of the line. The other end of the line is typically wound around a spool housed on the reel and allows the angler to wind or unwind the line to bring the fish in after the fish has been hooked.

Reels and rods come in numerous styles and combinations depending on the application, marine environment, and types of fish intended to be caught. The application and marine environments can vary from on-shore, off-shore, deep sea, shallow water, fresh water, salt water, moving, trawling, and/or remaining stationary. Reels can be of several varieties including, but not limited to, conventional reels, spinning reels, baitcasting reels, fly reels, and spin cast reels. Likewise, rods come in many varieties including, but not limited to, casting rods, spinning rods, ultra-light rods, fly rods, telescoping rods, surf rods, and trolling rods. The use of a particular rod with a particular style of reel again depends on the application, marine environment, and types of fish intended to be caught. The various rod and reel styles and combination of styles can be used hands-free or hands-on.

Typically, when a rod and reel are being continuously held by the angler, the typical hand placement and angle can cause undue strain and stress on the angler's hand, wrist, and forearm muscles, tendons, and bones. Anglers may shift the rod back and forth between hands to alleviate this stress and strain, but the problem remains. Other anglers may even set the rod down into a holder removing the rod from their hands entirely; while this alleviates the stress and strain temporarily it will return as soon as the angler holds the rod again. Resting the rod in a holder is also undesirable as obviates the angler's tactile response and ability to detect whether a fish is biting or taken the hook and can lead to a delay in detecting or hooking a fish since the angler must pick up the rod and re-establish their grip. The hands-off or resting the rod approach can lead to missed opportunities for the angler while fishing.

Applicant is aware of prior attempts to provide a more comfortable or more controlling handle for various types of fishing rods; however, each of these fails to overcome the problems solved by the present invention.

First, U.S. Pat. No. 2,116,158 to Pontis attempts to provide a contoured grip for a fishing rod, but the caster's grip is substantially behind the reel and reel seat. Pontis's positioning fails to achieve the same results of the present invention.

U.S. Pat. No. 4,648,196 to Moody concerns comfort attachments for a spinning rod to be attached at the reel shank for a bottom-mounted reel. The user's grip is substantially over or in-line with the reel, reel shank, and reel seat. The main goal of Moody is to provide comfort or protection to the caster's fingers that are in direct contact with the reel shank of a spinning rod with a bottom-mounted reel. Moody fails to achieve the same results of the present invention.

U.S. Pat. No. 4,905,400 to Brackett, et al. attempts to provide a contoured grip for a spinning rod with a bottom-mounted reel, but the caster's grip is substantially over or in-line with the reel, reel shank, and reel seat. Brackett's positioning and application to a bottom-mounted reel fail to achieve the same result of the present invention.

U.S. Pat. No. 5,461,818 to Balkcom provides a spinning rod with a bottom-mounted reel and finger grips on either side of the bottom-mounted reel shank. Like Brackett, et al., a user of Balkcom's assembly would position their hand substantially over or in-line with the reel, reel shank, and reel seat. Balkcom's positioning and application to a bottom-mounted reel fails to achieve the same result of the present invention.

US Patent Application Publication US2006/010702 A1 by LaCoste attempts to provide a contoured pistol-grip handle forward of the reel and reel seat on a casting rod. However, LaCoste's design offset's the caster's holding hand from the rod, wherein the hand is to the side of the rod rather than in line with the rod. LaCoste's positioning and orientation of the offset pistol-grip handle, in and of itself, and the additional arm support appear to be directed more for holding comfort and stability, rather than the results achieved by the present invention.

### SUMMARY OF INVENTION

The present invention typically concerns casting rods and provides an improved handle which orients a finger trigger hold on the handle forward relative to the reel seat. This improvement provides superior flexibility, comfort, and support versus convenient casting rod handles. Prior conventional casting rod handles provide a handle completely rear of the reel seat, wherein the angler's holding hand is situated behind the reel and reel seat. The conventional placement of the finger trigger hold on the conventional handle results in undue strain and stress on the angler's hands, wrists, and forearm muscles, tendons, and bones. The conventional placement of the finger trigger hold also provides a weak pivot or fulcrum point with the angler's hand positioned behind the reel and reel seat.

The improved casting rod handle with at least a finger trigger hold forward of the reel seat provides an increased amount of torque that can be applied to the rod by the angler's holding hand. A casting rod incorporating the improved handle allows the angler's hand position to be the fulcrum while positioning the reel and reel seat substantially behind the angler's holding hand, providing stronger hooksets and more control when catching and reeling in fish. The improved handle also allows for greater sensitivity for the angler to be able to detect when the fishing line has been pulled by allowing the holding hand or one or more fingers of the holding hand to be in contact with the line. The improved handle positioning the angler's holding hand forward of the reel also allows the angler's holding hand to manipulate the fishing line providing further sensitivity to actions occurring on or to the fishing line. Alternative embodiments of the improved handle can be provided to be form fitting to match a angler's natural hand grip, comfort fit, custom molded, left-hand, or right-hand or ambidextrous grips, and/or various sizes to accommodate children to adult hand sizes.

### BRIEF DESCRIPTION OF DRAWINGS

For a more complete understanding of the present disclosure and the advantages thereof, reference is now made to the following descriptions to be taken in conjunction with the accompanying drawings depicting specific embodiments of the disclosure, wherein:

FIG. 1 is an isometric depiction of a typical casting rod and reel incorporating the improved handle of the present invention.

FIG. 2a is a prior art version of a casting rod and handle configuration depicting the interactions of forces and pivot point embodied in the prior art configuration.

FIG. 2b is an embodiment of the present invention depicting the interactions of forces and pivot point created by the present invention.

FIG. 3 is a side view of the improved handle of the present invention.

FIG. 4 is a cross-sectional view of an embodiment of the improved handle of the present invention.

FIG. 5 is a cross-sectional view of an alternative embodiment of the improved handle of the present invention.

### DETAILED DESCRIPTION

One or more illustrative embodiments incorporating the invention disclosed herein are presented below. Applicant has created an improved casting rod handle for fishing applications and uses.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted since such details are not necessary to obtain a complete understanding of the present disclosure and are within the skills of persons of ordinary skill in the relevant art.

Referring to the drawings in general, it will be understood that the illustrations are for the purpose of describing embodiments of the disclosure and are not intended to be limiting thereto. Drawings are not necessarily to scale, and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. Definitions and/or interpretations should not be incorporated from other patent applications, patents, or publications, related or not, unless specifically stated in this specification, or if the incorporation is necessary for maintaining validity.

Certain terms are used in the following description and claims to refer to system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form, and some details of conventional elements may not be shown, all in the interest of clarity and conciseness.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

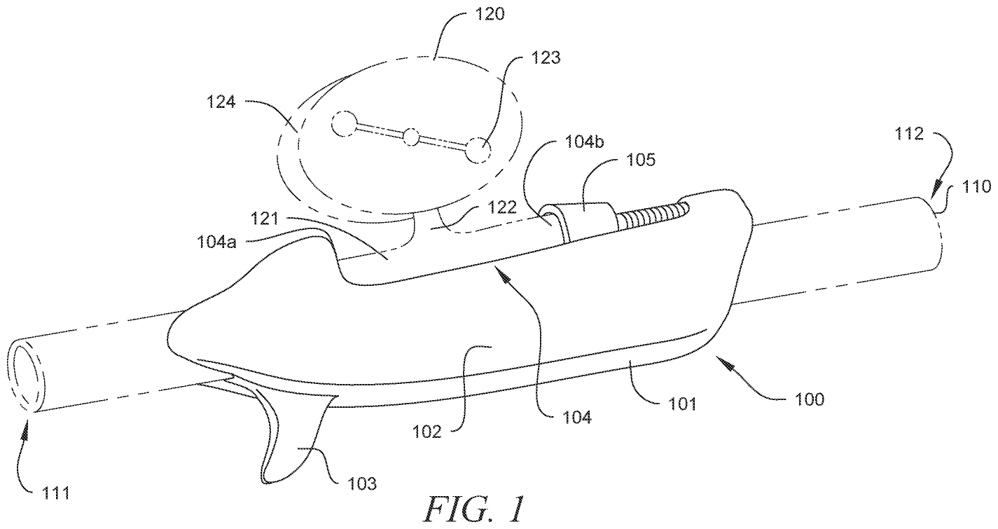

FIG. 1 illustrates one embodiment of the present invention, the improved casting rod handle 100, in conjunction with a typical casting rod 110 and reel 120. The typical casting rod 110 comprises a forward end 111 and a rear end 112, wherein a fishing line would typically be threaded through eyelets spaced along a surface of the rod 110 between the forward end 111 and the reel 120. The reel 120 typically comprises a reel foot 121, reel body 122, reel handle 123, and spool 124. Of course, reels may and typically do include other parts such a tensioning adjustment, release buttons, and level winds among others, but for simplicity of explanation these parts are not addressed in this description. Persons of ordinary skill in the art would understand the typical parts and functioning of a reel. The handle 100 comprises a grip 101, which comprises a gripping surface 102, a trigger finger hold 103, a reel seat 104, and a locking nut 105. The reel seat 104 comprises a forward portion 104a and a rear portion 104b. The trigger finger hold 103 is situated forward of the rear portion of the reel seat 104. The reel seat 104 allows for the reel foot 121 to be inserted into the forward portion 104a and rear portion 104b and secured with locking nut 105. The handle 100 comprises a threaded surface formed on a surface of the handle adjacent to the reel seat. The locking nut 105 comprises an outer surface and an inner surface, the inner surface being threadedly engaged with the threaded portion of the handle 100 adjacent to the reel seat 104. The locking nut 105 can be tightened through the threaded engagement with the threaded surface of the handle to secure at least a portion of the reel foot 121 within the reel seat 104. A second portion of the reel foot 121 may be secured to a second portion of the reel seat 104 or handle 100 by insertion of the second portion of the reel foot 121 into a mating engagement formed on or in the reel foot 121 or handle 100. It should be appreciated by persons of ordinary skill in the art that alternative embodiments can be used for the locking nut including press fit engagements, spring loaded locking devices, among others. The description of the threaded engagement of the locking nut should not be construed to be limiting for embodiments or manners of securing the reel foot 121 to the reel seat 104 or handle 100. Further, the locking nut 105 can be embodied in a forward position on the handle 100 to secure a forward portion of reel foot 121 to the forward portion 104a of the reel seat 104 or, alternatively, the locking nut 105 can be embodied in a rear position on the handle 100 to secure a rear portion of the reel foot 121 to the rear portion 104b of the reel seat 104.

It should be appreciated by persons of ordinary skill in the art that the improved casting rod handle can be made of varying materials or combinations of materials including, but not limited to woods, plastics, polymers, rubbers, cork, or metals. Additionally, the size, length, depth, and diameter of the finger trigger hold can vary as well as the size of the improved casting rod handle itself including the length, depth, and diameter. It should also be appreciated that the rigidity of the materials comprising the improved casting rod handle can be varied to modify the feel or grip of the improved casting rod handle for comfort or improved handling.

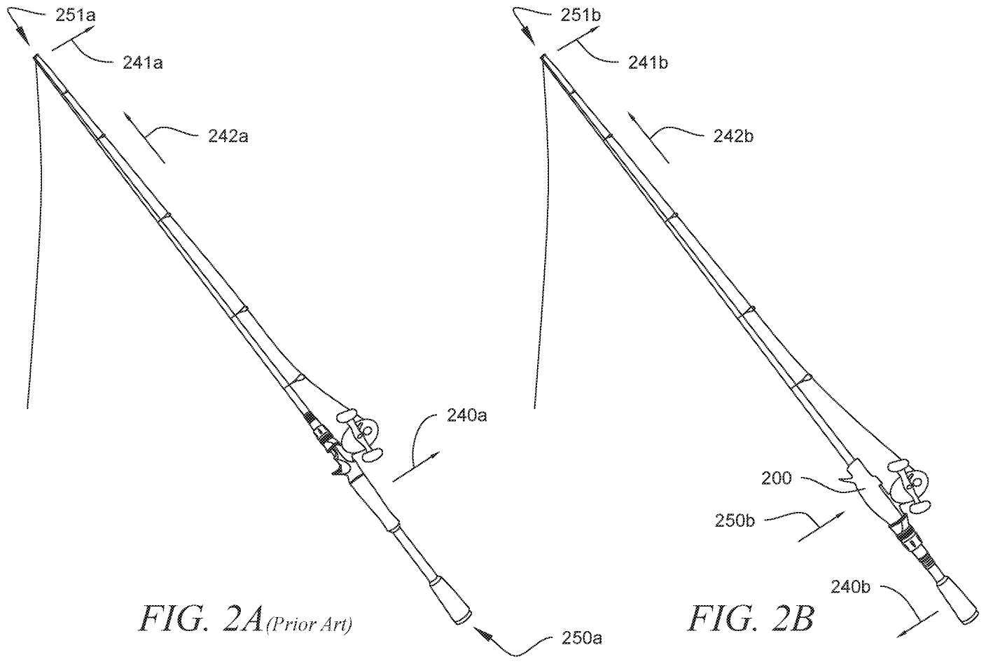

FIGS. 2a and 2b illustrate a comparison of prior casting rod and handle arrangements and the present invention in conjunction with a typical casting rod and the interaction of forces applied during use of the casting rods. As depicted in FIG. 2a prior casting rods are typically class 3 levers, wherein the rear portion of the rod acts as the fulcrum 250a, a force is applied forward of the fulcrum point causing the rod to move across an axis. Typically, the angler will pull back on the rod exerting force 240a while pivoting the rod at the rear of the rod 250a. The force 241a and movement of the rod are then magnified at the forward end of the rod 251a. This movement along an axis causes tension 242a in the fishing line. As shown in FIG. 2b, the improved casting rod handle 200 converts the rod into a class 1 lever wherein the fulcrum or pivot point 250b is situated between the force input 240b, the improved handle, and the forward end of the rod 251b. The force 241b and movement of the rod are then magnified at the forward end of the rod 251b. This movement along an axis causes tension 242b in the fishing line. The improved casting rod handle configuration allows for a greater amount of force to be exerted with less input force.

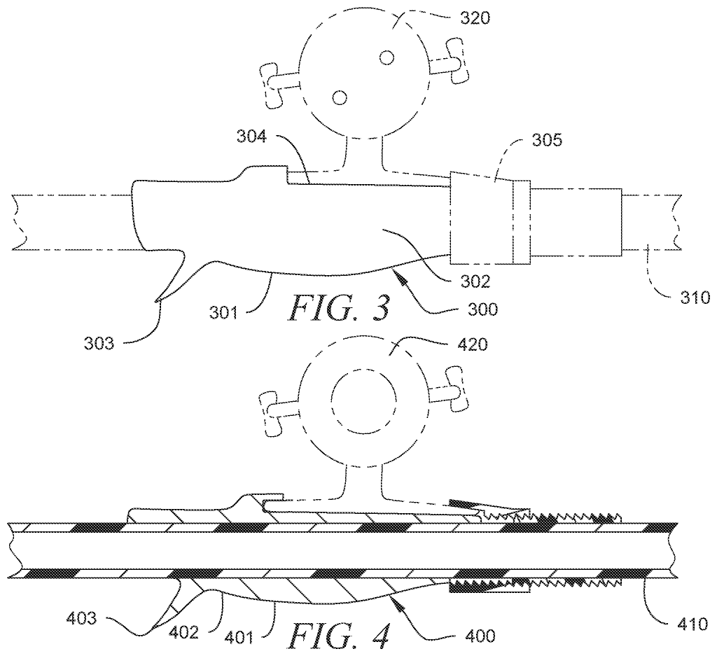

FIG. 3 illustrates an embodiment of the present invention in a side profile depiction comprising the improved casting rod handle 300, casting rod 310, and reel 320. The casting rod 310 and reel 320 are a typical rod and reel for purposes of this description and may include the parts and portions as described in this disclosure. The improved casting rod handle 300 comprises a grip 301, which comprises a gripping surface 302, a trigger finger hold 303, a reel seat 304, and a locking nut 305.

FIG. 4 illustrates a cross-sectional embodiment of the present invention comprising the improved casting rod handle 400, casting rod 410, and reel 420. The casting rod 410 and reel 420 are a typical rod and reel for purposes of this description and may include the parts and portions as described in this disclosure. The improved casting rod handle 400 comprises a grip 401, which comprises a gripping surface 402, a trigger finger hold 403, a reel seat 404, and a locking nut 405. The locking nut 405 is provided to move along the exterior surface of the handle 400 to provide engagement with at least a portion of the reel foot of reel 420.

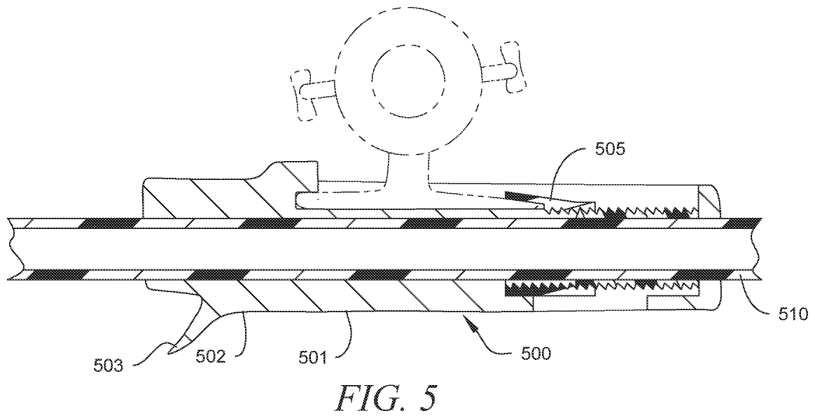

FIG. 5 illustrates a cross-sectional view of an alternative embodiment of the present invention comprising the improved casting rod handle 500, casting rod 510, and reel 520.

The casting rod 510 and reel 520 are a typical rod and reel for purposes of this description and may include the parts and portions as described in this disclosure. The improved casting rod handle 500 comprises a grip 501, which comprises a gripping surface 502, a trigger finger hold 503, a reel seat 504, and a locking nut 505. The locking nut 505 is provided to move along an interior surface of the handle 500 to provide engagement with at least a portion of the reel foot of reel 520. The handle 500 can be design in various ways, including but not limited to, a slit, window, gap in the body of the handle to allow for access to turn or manipulate the locking nut 505 or other locking mechanism for securing the reel foot of the reel 520.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

What is claimed is the following:

1. A casting rod handle comprising:
a handle comprising a reel seat, a grip portion, and a finger trigger member;
the handle comprising a forward end, a rear end, a top surface, a bottom surface, and plurality of side surfaces;
said reel seat is situated on said top surface between said forward end and said rear end and comprises a reel seat engagement ring;
said finger trigger member is formed on said bottom surface and positioned closer to the forward end than the rear end and substantially forward of the reel seat.

2. The casting rod handle of claim 1 further comprising: said reel seat engagement ring threadedly engages an exterior perimeter of the handle

3. The casting rod handle of claim 1 further comprising: said reel seat engagement ring threadedly engages an interior surface of the handle.

4. The casting rod handle of claim 2 further comprising: said reel seat further comprises a forward engagement indention for receiving a reel foot member.

5. The casting rod handle of claim 3 further comprising: said reel seat further comprises a forward engagement indention for receiving a reel foot member.

6. The casting rod handle of claim 2 further comprising: said reel seat further comprises a rear engagement indention for receiving a reel foot member.

7. The casting rod handle of claim 3 further comprising: said reel seat further comprises a rear engagement indention for receiving a reel foot member.
